(19) United States
(12) Patent Application Publication
(10) Pub. No.: US 2017/0324733 A1
(43) Pub. Date: Nov. 9, 2017

(54) USING SECURITY POSTURE INFORMATION TO DETERMINE ACCESS TO SERVICES

(71) Applicant: INTERDIGITAL PATENT HOLDINGS, INC., Wilmington, DE (US)

(72) Inventors: Dolores F. HOWRY, Malvern, PA (US); Vinod Kumar CHOYI, Conshohocken, PA (US); Alec BRUSILOVSKY, Downingtown, PA (US); Yogendra C. SHAH, Exton, PA (US)

(21) Appl. No.: 15/528,288

(22) PCT Filed: Nov. 20, 2015
(86) PCT No.: PCT/US15/61857

§ 371 Date: May 19, 2017

Related U.S. Application Data
(60) Provisional application No. 62/083,012, filed on Nov. 21, 2014.

(51) Int. Cl. H04L 29/06; H04W 12/06; H04W 76/02; H04W 88/02

(52) U.S. Cl. CPC H04L 63/0823; H04W 12/06; H04W 76/023; H04L 63/105; H04L 63/20; H04W 88/02

(57) ABSTRACT

Current approaches to using security postures lack functionalities. Security postures can be used to enable various nodes to make informed decisions. In accordance with one embodiment, a system comprises a first node and a second node. The first node receives a security posture associated with the second node. The security posture provides a verifiable point-in-time trust metric on an overall level of trust in the second node. The first node compares the security posture associated with the second node to an expected security posture level associated with the first node. If the security posture associated with the second node is adequate as compared to the expected security posture level, a connection is established between the first node and the second node.

This application claims the benefit of U.S. Provisional Patent Application Ser. No. 62/083,012, filed Nov. 21, 2014, the disclosure of which is hereby incorporated by reference as if set forth in its entirety herein.

### BACKGROUND

A security posture is typically considered to be a dynamic indication of the current security state of a network node, for instance a device. The security posture of a given device may indicate the security implemented on the device. For example, the security posture may to used to infer which applications (e.g., anti-virus, anti-malware) run on the device or which version of an operating system (OS) runs on the device. The security posture is considered dynamic because it may change as the device changes. For example, an example security posture may change as applications are added or removed from the device, as device configurations are changed, as new vulnerabilities are discovered, as applications are added or patched, as operating systems are added or patched, as kernels are added or patched, as device drivers are added or patched, etc. The concept of a security posture has been adopted by the Trusted Computing Group (TCG) as part of the Trusted Network Connect protocol. Security postures have also been adopted by the Internet Engineering Task Force (IETF) as part of the Network Endpoint Assessment protocol. Existing approaches to using security postures lack functionality, and thus nodes lack capability that can be facilitated using security postures.

### SUMMARY

Described herein are methods, devices, and systems that use security postures of various nodes to make informed decisions, such as decisions related to network and service access for example. In accordance with one embodiment, a system comprises a first node and a second node. The first node receives a security posture associated with the second node. The security posture provides a verifiable point-in-time trust metric on an overall level of trust in the second node. The first node compares the security posture associated with the second node to an expected security posture level associated with the first node. If the security posture associated with the second node is adequate as compared to the expected security posture level, a connection is established between the first node and the second node. In one example, the first node is a user equipment, the second node is a network access point, and the established connection includes a network access for the user equipment. In another example, the first node is a network access point, the second node is a user equipment, and the established connection includes a network access for the user equipment. In yet another example, the first node is a first user equipment, and the second node is a second user equipment, and the established connection is a peer-to-peer communication session. In still another example, the first node is a user equipment, the second node is a service provider, and the established connection includes access to a service provided by the service provider. Further, a granular indication may represent the security posture of the service, and the granular indication may be displayed to a user of the user equipment. The security posture may be contained within a certificate or scorecard, for example.

### BRIEF DESCRIPTION OF THE DRAWINGS

A more detailed understanding may be had from the following description, given by way of example in conjunction with the accompanying drawings wherein:

FIG. 1 is a call flow that depicts two network nodes setting up a communication connection between them in accordance with an example embodiment;

FIG. 2 is an example of a security posture contained in a certificate in accordance with an example embodiment;

FIG. 3 is a call flow that shows an example of a user equipment (UE) selecting a network based on security postures that are associated with a plurality of candidate networks;

FIG. 4 is a call flow that shows an example of network-assisted network selection based on security postures in accordance with an example embodiment;

FIG. 5 is a call flow that shows an example of a network mobility manager (NMM) selecting a network for a UE based on security postures in accordance with another example embodiment;

FIG. 6 is a call flow that shows an example of a UE selecting an access point without assistance from the network in accordance with an example embodiment;

FIG. 7 is a call flow that shows a UE providing a security posture in a layered manner in accordance with an example embodiment;

FIG. 8 is a call flow that shows two UEs establishing a peer-to-peer (P2P) connection with each other based on security postures;

FIG. 9 is a call flow that shows two UEs establishing a (P2P) connection via a Posture Verifier and Broker (PVB) in accordance with another example embodiment;

FIG. 10 is a call flow that shows various nodes in a network verifying security postures in accordance with yet another example embodiment;

FIG. 11A is a system diagram of an example communications system in which one or more disclosed embodiments may be implemented;

FIG. 11B is a system diagram of an example wireless transmit/receive unit (WTRU) that may be used within the communications system illustrated in FIG. 11A; and

FIG. 11C is a system diagram of an example radio access network and an example core network that may be used within the communications system illustrated in FIG. 11A.

### DETAILED DESCRIPTION OF ILLUSTRATIVE EMBODIMENTS

As described above, current approaches to using security postures lack functionalities. For example, when a node, such as a user equipment for example, accesses a network or application using secure access procedures (e.g., 802.1x/EAP in WLAN networks, web portals, application servers, etc.), security postures of the UE and the node to which the UE connects are not currently taken into account. It is recognized herein that users may be concerned with the security associated with a particular network access point (AP), for instance a hotspot, and not just the authentication method used to access the AP or the type of link layer protection used to gain access. By way of further example, it is also recognized herein that hotspot networks want trustworthy users and user devices to access their networks so that the networks are not exposed to unnecessary security threats. In current approaches to network access, little information regarding the security associated with various network nodes, for instance devices and/or hotspots, is available such that a node can make an informed policy decision regarding network attachment. Such network attachment may include, for example, Wi-Fi offloading, hotspot selection, and UE selection prior to network attachment.

In accordance with an example embodiment, new parameters are used to enable optimized network attachment. For example, as described below, pre-established security associations and network initiated mechanisms may be used to facilitate optimized network discovery and selection.

As used herein, any functional entity can be referred to as a node, without limitation. For instance, a node may be a user equipment, a network entity, a server, an access point, a service provider, a service, an application, a tablet, a mobile device, or the like. Further, as used herein, a security posture may also be referred to as a security posture value (SPV) or a security posture level, without limitation. As further described below, a security posture may be represented quantitatively or qualitatively. The security posture may provide a verifiable point-in-time trust metric on the overall level of trust in a node. An expected security posture level (ESPL) is also used herein. An ESPL may refer to a static indication of a particular security posture that is required by a given node. For example, a given node may have a particular ESPL for communicating with another node. By way of further example, a mobile device used for secure banking may have an expected security posture level that is set to “HIGH.” Such an ESPL may indicate that access to the mobile device requires certain minimum security capabilities, such as SIM based authentication and tunneled communications for example. Continuing with the example, a device with a “LOW” expected security posture level may indicate that the device performs functions that do not required significant security. The ESPL is generally considered to be a static indication that is changed infrequently. A node, for instance a UE, may have more than one ESPL. For example, a UE may have various expected security posture levels (ESPLs) based on various modes in which the UE operates. By way of example, a given UE may have a first ESPL that is classified as “MEDIUM” when the UE operates in a “personal workspace” mode, and the UE may have a second ESPL that is classified as “HIGH” when the UE operates in an “Enterprise workspace” mode.

As described further below, an ESPL can be stored by a network or a device and can be used to make policy based access control decisions. An expected security posture level can be represented as, for example and without limitation, a single value, a group of indicators, or part of a certificate. As described below, an ESPL of a first node can be compared with a security posture (e.g., an SPV) that is offered by a second node in order to make decisions and take appropriate actions.

As described below, security postures are extended to indicate an evaluation of systems. Such evaluations may include, for example, a vulnerability assessment, penetration testing, or a TRA of live, production or development systems. Security postures may be represented as a numerical value or a qualitative value (e.g., High/Medium/Low). In various embodiments described below, security postures of various nodes are compared with each other to determine whether services should be offered or obtained.

A device or network security posture can be based on the Trusted Network Computing (TNC) protocols. Such security postures may indicate various information such as, for example, security software that is being used on a node, network interfaces that are enabled on a device, and network interfaces that are active on a device. Additional information may be indicated so as to provide a health check of a given device's hardware and/or software applications. Further, security posture information may indicate whether a particular secure element (e.g., smart card, universal integrated circuit card (UICC), Trusted Execution Environment (TEE)) exists on a given device.

The security posture of a device may indicate, for instance include, parameters associated with security applications (e.g., a list of virus detection applications, the scan status associated with each virus detection application, a time of the last vulnerability assessment by way of security scan results) that are on the device. For example, parameters may indicate the status of particular security applications, such as whether applications are currently loaded or unloaded, active or inactive, etc. Example applications and associated information that may be identified by a security posture include, without limitation, anti-malware applications, anti-virus applications, intrusion detection applications, OS versions, and versions of OS components (e.g., kernel, device drivers, etc.). Hardware specific information, such as an identification of trust modules, may be also be indicated by security postures, which can also be referred to generally as security posture reports.

A network-side security posture may indicate information regarding the types of security verifications that are available and the level at which they are performed. Security information, such as authentication protocols, cryptographic protection levels (e.g., FIPS reference, etc.), accreditation levels (e.g., CC certification, Protection Profile level), Anti-Virus ratings, and the like may be reported via network side security postures. For example, a security posture value (SPV) of a network may be computed as an average of the security postures of each of the nodes, which can also be referred to as entities, that make up that network (e.g., SPVNetwork=1/n Σi=1 n SPVi), wherein SPVi is a measure of the SPV of each relevant entity, for instance every entity, within the network infrastructure. Alternatively, by way of further example, the security posture of the network may be equal to the lowest computed security posture of the relevant entities, for instance all the entities, within the network (e.g., SPVNetwork=min {SPV1, SPV2, SPV3 . . . SPVn}).

Traditionally, it is understood that business relationships between operator networks are pre-arranged by means of a service level agreement (SLA). These relationships generally take into account static requirements for the networks involved to adhere to established best practices and standards. It is recognized herein that there are often limitations associated with these relationships. For example, these relationships are not dynamic in nature, and therefore new relationships cannot be created efficiently. Another example limitation is that the security postures of networks change quickly, and there might not be a way for new relationships to be created based on a network's dynamic (updated) security posture. Thus, associations may be created between nodes that are based on obsolete security postures. Such associations may have to be terminated or curtailed based on an inadequate security posture. As described below, various embodiments disclosed herein enable nodes to select candidate services, networks, or applications (e.g., handover or offload) based on a current SPV of the candidate services, networks, or applications, in a more dynamic manner as compared to existing approaches.

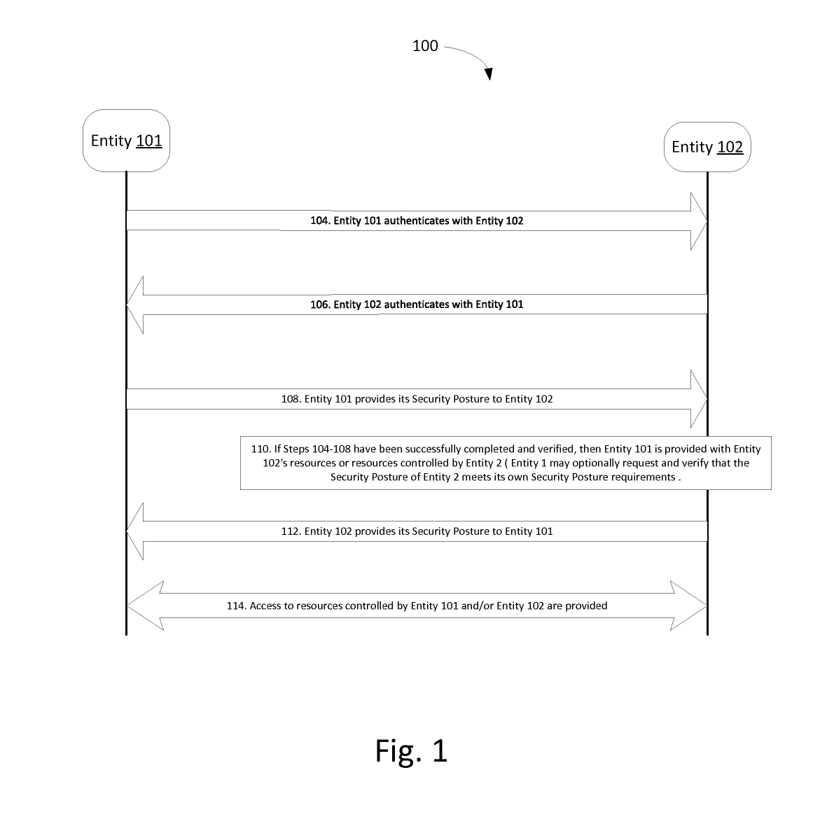

Referring now to FIG. 1, an example communication system 100 includes a first entity 101 and a second entity 102 that communicate with each other. The terms entity and node are used interchangeably herein, without limitation, unless otherwise specified. It will be appreciated that the example system 100 depicted in FIG. 1 and portions thereof are simplified to facilitate description of the disclosed subject matter and is not intended to limit the scope of this disclosure. Other devices, systems, and configurations may be used to implement the embodiments disclosed herein in addition to, or instead of, a system such as the system 100 depicted in FIG. 1, and all such embodiments are contemplated as within the scope of the present disclosure.

In accordance with the illustrated embodiment, at 104, Entity 101 authenticates with Entity 102. This step may contain multiple steps that are performed between the two entities, for example an authentication challenge and response. In some cases, this authentication is optional and the authentication may be carried out after an SPV of Entity 101 is verified (Step 108). At 106, in accordance with the illustrated example, Entity 102 authenticates with Entity 101. It will be understood that Entity 101 and Entity 102 may authenticate each other at 104. Alternatively, the authentication at 106 may be carried out after Entity 101 verifies that an SPV associated with Entity 102 is above a threshold required by Entity 101. Such a threshold can be referred to as the ESPL of Entity 101. At 108, Entity 101 provides its SPV to Entity 102. A request for the SPV of Entity 101 may have been included during the authentications described above. At 110, based on a policy, for example, only Entity 101's SPV is verified as being adequate before access to service or resources is provided by Entity 102 to Entity 101. By way of an alternative example, a policy may stipulate that Entity 102's SPV is verified by Entity 101 before access to resources or services are provided. It will be understood that polices may be configured to require any SPV as desired. At 112, in accordance with the illustrated example, Entity 102 provides its SPV to Entity 101. Based on the provided SPV, Entity 101 may be able to trust Entity 102's security worthiness with a degree of certainty. At 114, in accordance with the illustrated example, if Entity 101's SPV is higher than the threshold required by Entity 102, and if the SPV of Entity 102 is higher than the threshold (EPSL) required by Entity 101, then the entities may be connected with each other and each entity may be able to access resources from the other entity.

Thus, in some cases, Entity 101 and Entity 102 may require connectivity between them, such that services can be shared between them. For example, services may be provided by Entity 102 to Entity 101. Further, Entity 101 may be required to present its SPV to Entity 102, and/or Entity 102 may be required to present its SPV to Entity 101. Further still, the SPV of Entity 101 may be required to be at least equal to, for instance above, the ESPL (a threshold) of Entity 102, and/or the SPV of Entity 102 may be required to be at least equal to, for instance above, the ESPL (a threshold) of Entity 101. In accordance with another example embodiment described below, Entities in a Peer-to-Peer system or Entities belonging to a Group are provided with services and connectivity based on security postures of other peers or other members of the group.

Generally, the Expected Security Posture Level (ESPL) is a SPV that a first entity requires of a second entity when providing or receiving services for itself or on-behalf of a third entity. Thus, the ESPL may be referred to as a minimum Security Level or SPV that a requesting entity that requests service must meet in order obtain requested services. Example services include, presented without limitation, access to WiFi or LTE service, web service, subscription services, applications, access to data, etc.

Turning now to measuring security postures, an example security posture of an entity may be a quantitative or qualitative value, and may be measured using various metrics. Measuring the SPV of an entity may be related to the degree to which the network nodes (e.g., application servers, supplemental servers, security appliances or user equipment such as mobile devices, tablets, laptops, desktops, etc.) adhere to best practices and standards. For example, measurements may be carried out by the network operator and verified by another entity, such as a trusted third party entity. Alternatively, a trusted third party entity may carry out the measurements and vouch for (verify) the measurements. An entity that provides security posture information associated with a network may account for various information (e.g., parameters and assessments) when rating a node or a system via an SPV. For example, an entity that provides security posture information associated with a network may account for a common rating of the network as a whole or a portion of the network. A portion of the network may include relevant entities within the network. For example, the entity that provides an SPV may account for a rating of a subset of entities that are involved in a certain transaction (e.g., web servers or elements involved in network offloading).

It will be understood that an entity that provides security posture information associated with a network may account for any information as desired. For example, the entity may account for an assessment of protection mechanisms (layered access control). Example protection mechanisms that can be assessed include, without limitation, perimeter protection using firewall, intrusion prevention systems with up-to-date signatures, proxy servers, access control lists at the routers and switches, anti-malware/anti-virus applications, host intrusion prevention system (HIPS) on user devices (e.g., mobile phones, tablets, laptops, desktops, etc.), application and OS controlled access control mechanisms (e.g., employing 1-3 factors of authentication), and whether secure protocols (e.g., TLS, EAP, DTLS, IPSec, etc.) are used. By way of further example, the entity may account for whether a secure element, such as a trusted execution environment (TEE) or smart card (e.g., UICC or SIM) is used. By way of further example, the entity may account for whether hardware root-of-trust or secure boot process is used, a rating that is provided as part of a Threat and Risk Assessment (TRA), or a rating that is provided after a vulnerability assessment, penetration testing, or an audit. Such an audit or assessment may include a rating of the operating system (OS) of various devices, such as servers, routers, desktops, user equipment, or the like. Web applications and portals may also be rated, for example by using an IBM Appscan tool. Databases may also be assessed, for example by using DbProtect, such that the vulnerability of various databases (e.g., Oracle, SQL, etc.) can be assessed. As mentioned above, it will be understood that an entity that provides security posture information associated with a network may account for any information, which includes ratings and assessments of individual network components and entire networks, as desired.

Turning now to representing security posture values, an SPV may be represented as certificates (e.g., Class 2 or Class 3). The certificates may be signed or unsigned, although it is often preferred that such a certificate is signed. A given SPV may, alternatively, be represented in other forms, such as Security Posture Scorecards or in the form of a JSON encoded format, for example. The certificates may be issued by an organization that performs some form of validation of a system's security posture.

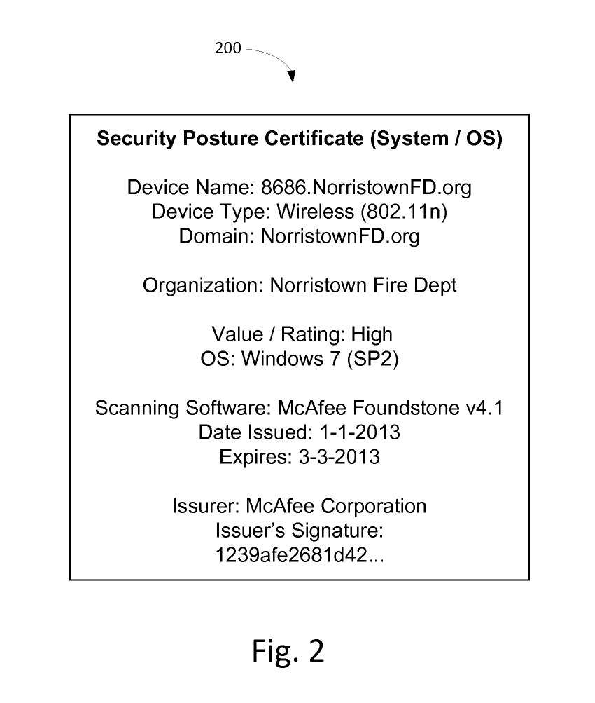

Referring now to FIG. 2, the SPV of an entity may be represented in the form of a digital certificate that is similar in spirit to an X.509 certificate. In FIG. 2, an example certificate 200 is shown that is issued to a device that is identified by its Device name (8686.NorristownFD.org). As shown, the device belongs to the Norristown Fire Department. The rating given to the device's Security Posture is “High” and the device runs on the Windows 7 (SP2) OS. The authority that conducted the analysis is McAfee and the McAfee Foundstone v4.1 vulnerability assessment tool was used. McAfee had issued the certificate that was signed by McAfee's private key. As shown, the certificate has a validity from Jan. 1, 2014 to Mar. 3, 2015.

It will be understood that similar or alternative certificates may be issued by an evaluating entity (e.g., McAfee) once an assessment (such as a vulnerability assessment for example) is performed on a web application/portal, database, etc. The certificates may be stored locally within a secure hardware module and invoked, for example, by a Trusted Execution Environment that is virtualized or via a Trusted Platform Module/Trusted Execution Environment. SPV certificates may additionally, or alternatively, be stored securely in a network element or server and fetched when needed using secure mechanisms.

In accordance with another embodiment, a certificate may contain the cumulative SPV of an entire network, thus providing an indication of the trustworthiness of the network or Operator or Service provider and the supporting infrastructure, and not just an individual entity or device. Alternatively, a grouping of certificates associated with each of various networks, applications, or relevant entities may be provided.

In one embodiment, certificates that are issued are created by evaluating the SPV of the relevant nodes associated with a given application, service, infrastructure, or network. If a service that is being offered is an application web service, for example, then the service provider of the service may be provisioned with certificates relevant to the platform that is being used. Such certificates may vouch for an SPV associated with a server's operating system(s), virtualization software being used, connections to databases, databases, web applications, networking components being used, and optionally the application that resides on an end-user device. Separate assessment mechanisms for computing the SPV of each of the components may be carried out, or an assessment that tests the trustworthiness of the entire platform may be carried out, or a combination thereof may be carried out.

As explained above, the evaluation methodology may involve various mechanisms such as Vulnerability Assessments, Penetration Testing, Threat Risk Assessments (TRA), Common Criteria evaluation, or other means, or a combination thereof. The methodology and mechanisms that are used to compute the SPV may be selected by the entities that perform the actual evaluation or selected based on best practices identified by standardization bodies (e.g., NIST).

Certificates associated with individual components of a platform may be provisioned upon conclusion of the above-mentioned analysis or testing. The certificates may represent a cumulative SPV of the platform. A consumer of a service may be provisioned with an appropriate set of policies so that the consumer may use the certificates to assess the trustworthiness of a service provider before a respective service is consumed. Policies may dictate whether the SPV of an entire platform is required. Policies may further stipulate whether the SPV of each component is required or whether a cumulative SPV is permitted or required.

In accordance with an alternative embodiment, an SPV may be represented by a scorecard. For example, scorecards may be used in environments that require more dynamic information elements that may be updated frequently. Scorecards may also be used for low footprint devices that are constrained in power and processing capability, such as resource-constrained machine-to-machine (M2M) devices for example (e.g., sensors). In some cases, the scorecards need not be digitally signed by way of a certificate chain. Thus, the scorecards may be used in trustworthy environments where trust may be established through recognized entities, rather than through a certificate chain root authority for example. It is envisioned herein that the scorecards may be collated from various network elements and presented in a combined manner to represent the SPV of the network, thus providing an indication of the trustworthiness of the network. Scorecards may be lighter-weight in terms of processing as compared to alternative mechanisms. Further, in some cases, scorecards may be updated more easily than certificates. As compared to certificates, scorecards may be less difficult and expensive to obtain and maintain. As previously mentioned, alternative mechanisms may be implemented to represent the security posture, such as a JSON encoded token (e.g., JSON Web Token (JWT)) or a signed object (e.g., by means of a JSON Web Signature (JWS) or JSON Web Encryption (JWE)).

Turning now to selecting nodes (entities), which may be devices or networks, based on security postures, which can also be referred to as security posture ratings, security posture values, or security posture levels without limitation, various use cases are presented below to describe various embodiments by way of example. In one example, a device selects an appropriate network for attachment based on the network's SPV. For example, a Mobile Network Operator (MNO) or any other network operator (e.g., cable operator) may select a candidate network (e.g., WiFi hotspot or 3/4G network) on behalf of a User Equipment (UE) so that the UE is provided with a point of attachment and offloaded to another high capacity network (e.g., the selected WiFi hotspot). Alternatively, the UE or User may select a network (e.g., WiFi, 3G, 4G, 5G) based on an SPV associated with each of a plurality of networks in vicinity of the UE. In another example use case, the network selects appropriate UEs based on each UE's SPV. In another example case described below, a UE selects an Application-level Web Services Provider or Portals (SP/RP) based on a Service Provider's SPV. In yet another example case described below, a web service provider (SP/RP) selects appropriate UEs based on the UE's SPVs. In yet another example case described below, a first UE selects a second UE for Peer-to-Peer (P2P) communication based on the first UE's SPV. Further, in a Group-based communications scenario, a UE's SPV may be used so that the UE is admitted to the Group based on the SPV of the other participating UEs participating in the group.

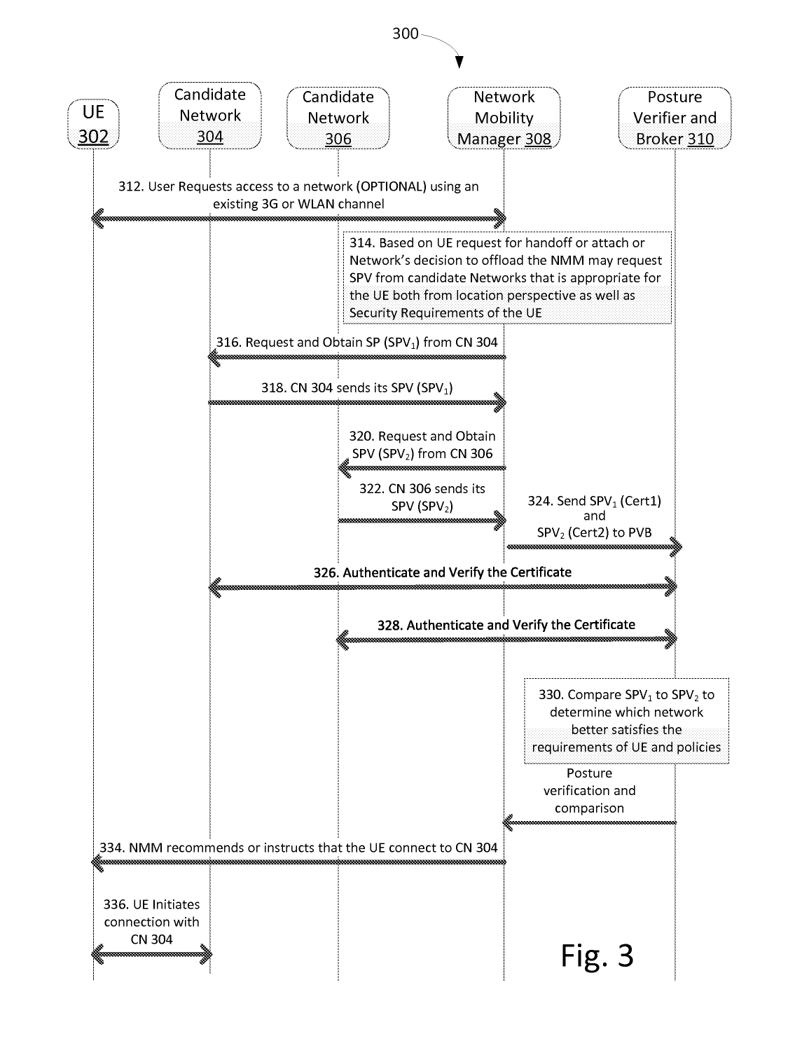

As mentioned above, in an example embodiment (e.g., see FIG. 3), a primary network, which may be a UE's home MNO network for example, selects a suitable secondary network so that the UE is provided with an attachment point to the secondary network or offloaded to the secondary network. In determining which secondary network to select, the security of candidate networks are evaluated. For example, the primary network may have a pre-established agreement with a particular secondary network provider such that the expected security posture level of the secondary network is known and can be trusted. In some cases, however, the SPV of a network may change over time based on changes to a platform (e.g., addition or removal of nodes, hardware, software, or firmware), OS upgrades, configuration changes, policy updates, addition or removal of enabling entities (e.g., databases, etc.), new vulnerabilities being discovered, or the like. Thus, the UE should attach to a network associated with an appropriate level of security in order to ensure that the UE does not connect to an unsecure network, which may result in the UE becoming compromised and further resulting in the UE's security posture being affected. In one example, the network informs the UE of the selected network or a list of possible networks that may be selected using an ANDSF protocol.

In another embodiment, the primary network may query a secondary network about its security posture by trying to obtain the secondary network's SPV. The SPV obtained from the secondary network may then be used by the primary network to determine if the secondary network is a worthy choice for offload or connectivity for the UE. The primary network may have a list of such trustworthy secondary networks to which the UE may connect, for example, which may include networks that have security posture values that are equal to or exceed the UE's ESPL or the primary network's ESPL.

Alternatively, a UE may select a secondary network directly on its own, with limited involvement or without any involvement of the primary network. In some cases, this scenario is less ideal, for instance when the UE knows little about the secondary network's SPV or when the cost to perform verification of a secondary network's SPV is expensive.

In another example embodiment described below, network attachment is considered from the secondary network's perspective. For example, network operators may wish to only allow access to those UEs with a certain SPV that at least meets the secondary network's ESPL. A network that may perform an SPV evaluation in order to protect its network from non-malicious or malicious messages emanating from compromised UEs. This scenario requires the secondary network to gather information regarding the security state (e.g., SPV) of the UE before allowing connectivity to the UE. In this example embodiment, in order for the network to provide access to a UE, the UE's SPV should meet or exceed the ESPL of that network.

Each example use case and scenario described herein has their own unique set of constraints and considerations. For example, in the case of a network selecting a secondary network, the mechanism by which the network conveys the hotspot or other network selection to the UE may be through mechanisms such as ANDSF. In some cases, if the UE does not have ANDSF capabilities, traditional secondary network selection procedures are not employed. The following descriptions describe enhancements to the network attachment scenarios introduced above such that the security information that is available to the primary network is leveraged by a secondary network and/or a UE.

Turning now to selecting an appropriate trustworthy network for handoff or offload, selecting an appropriate network for data offload or as a point of attachment may be carried out using the security posture value as one of the parameters. A UE may involve its home network or a trusted third-party in determining and selecting a candidate network for offload. In one example scenario, the UE may make the determination for the candidate network selection process on its own. Alternatively, the primary network (e.g., home network) may select an appropriate network for handoff or offload on behalf of the UE.

Referring now to FIG. 3, in some cases, a plurality of networks (e.g., WiFi, 4G networks) may be candidates for handoff or offload or a new attachment for a UE based on location, QoS offered, pricing, etc. Based on a set of characteristics and services offered by the available candidate networks, an entity trusted or controlled by a UE's primary network may use the Security Posture (SPV) of candidate networks to select an appropriate candidate network on behalf of the UE. The Security Posture Value (SPV) may be quantitative or qualitative in order to determine the security posture of candidate networks. A Network Mobility Manager (NMM) may invoke the services of other entities such as a Posture Verifier and Broker (PVB) function in order to determine the SPV of candidate networks or the NMM may determine or compute the SPV on its own based on its analysis. The PVB Functionality may belong to the same administrative domain as the NMM or may be located outside of the NMM. Alternatively, the PVB function and the NMM function may be co-located on the same server. Irrespective of where the NMM and PVB are located, the two entities share a trust relationship. The PVB may determine if the SPV of the candidate networks meets or exceeds the ESPL of the UE for which the network connectivity is being initiated. The Candidate Network (CN) whose SPV best satisfies (or is adequate) as compared to the UE's requirement (ESPL) and/or policies and SLAs governing the relationship between the UE and the home network, is then selected for connectivity in accordance with an example embodiment.

Still referring to FIG. 3, an example communication system 300 includes a UE 302, a first candidate network 304, a second candidate network 306, an NMM 308, and a PVB 310, which communicate with each other. It will be appreciated that the example system 300 depicted in FIG. 3 and portions thereof are simplified to facilitate description of the disclosed subject matter and is not intended to limit the scope of this disclosure. Other devices, systems, and configurations may be used to implement the embodiments disclosed herein in addition to, or instead of, a system such as the system 300 depicted in FIG. 3, and all such embodiments are contemplated as within the scope of the present disclosure.

In accordance with the illustrated embodiment, at 312, the UE 302 tries to attach to a network (e.g., WiFi or 3G network). For example, the UE 302 may use a side-channel to request access to a network, or the UE 302 might not request access to a network. At 314, based on a profile of the UE 302, a Security Posture requirement of the UE 302, or other attributes (e.g., location, QoS, etc.), the Network Mobility Manager (NMM) 308 identifies potential Candidate Networks for the UE 302 to connect or offload. In accordance with the illustrated example, the NMM 308 identifies the first CN 304 and the second CN 306, though it will be understood any number of candidate networks can be identified as desired. At 316, in accordance with the illustrated example, the NMM 308 communicates with the first CN 304 to obtain the Security Posture Value (SPV) of the first CN 304 or access point (AP) associated with the CN 304, which can be referred to as SPV₁. In some cases, this step may be skipped, for example based on policies, if the NMM 308 has a current SPV of the CN 304 and if the NMM 308 deems the certificate or scorecard, which contains the SPV, to be fresh. In such cases, the NMM 308 might not request the SPV from the first CN 304. At 3, the first CN 304 sends its SPV₁ to the NMM 308. As described above, the SPV₁ may be sent in the form of a certificate, a verifiable value, a scorecard, or the like. At 4, the NMM 308 contacts the second CN 306 and requests its SPV, which can be referred to as SPV₂. In some cases, step 4 may be skipped, for example based on policies, if the NMM 308 has a current and a valid SPV of the second CN 306. At 322, the second CN 306 forwards its SPV₂ to the NMM 308. The SPV₂ may be sent to the NMM 308 in the form of a certificate or other forms as previously described. The requests 316 and 320 for obtaining the SPV to the candidate networks 304 and 306 may be performed in parallel by the NMM 308.

At 324, the NMM 308 forwards the SPV₁ (e.g., certificate 1) and SPV₂ (e.g., certificate 2) to the Posture Verifier and Broker (PVB) function 310. The NMM 308 and the PVB function 310 may be co-located on the same entity, located on a different entity, or located on a different domain as each other. Regardless of location, the NMM function 308 and the PVB function 310 may share a trust relationship with each other. At 326, the PVB may optionally authenticate the first CN 304 in order to verify the real identity of the certificate owner. For example, if authentication is carried out, then it may be performed in an explicit manner or implicitly. At 326, the PVB 310 performs the authentication and certificate verification process with the second CN 306, which may be similar to the authentication and verification performed at 326. The PVB 310 may inquire with other candidate networks (CNs) to determine a best fit for the UE 302. At 330, the security postures (SPV₁ and SPV₂) are compared with each other to determine which security posture is best suited for the UE 302. In some cases, the security posture that indicates that its associated network is most secure as compared to the other candidate networks is selected. In the illustrated example, the SPV associated with the first CN 304 is adequate as compared to the ESPL of the UE 302, and the SPV associated with the first CN 304 is determined to be better than the SPV associated with the second CN 306. Thus, the PVB 310 selects the first CN 304 as the network (which can be an AP or Base station for example) to offload or attach. At 332, the result of the posture verification and comparison is communicated to the NMM 308. Specifically, in accordance with the illustrated example, at 332, the result indicates that first CN 304 is the preferred network for offloading or attaching. At 334, the NMM 308 recommends or instructs the UE 302 to connect to the first CN 304. At 336, the UE 302 establishes a connection with the first CN 304.

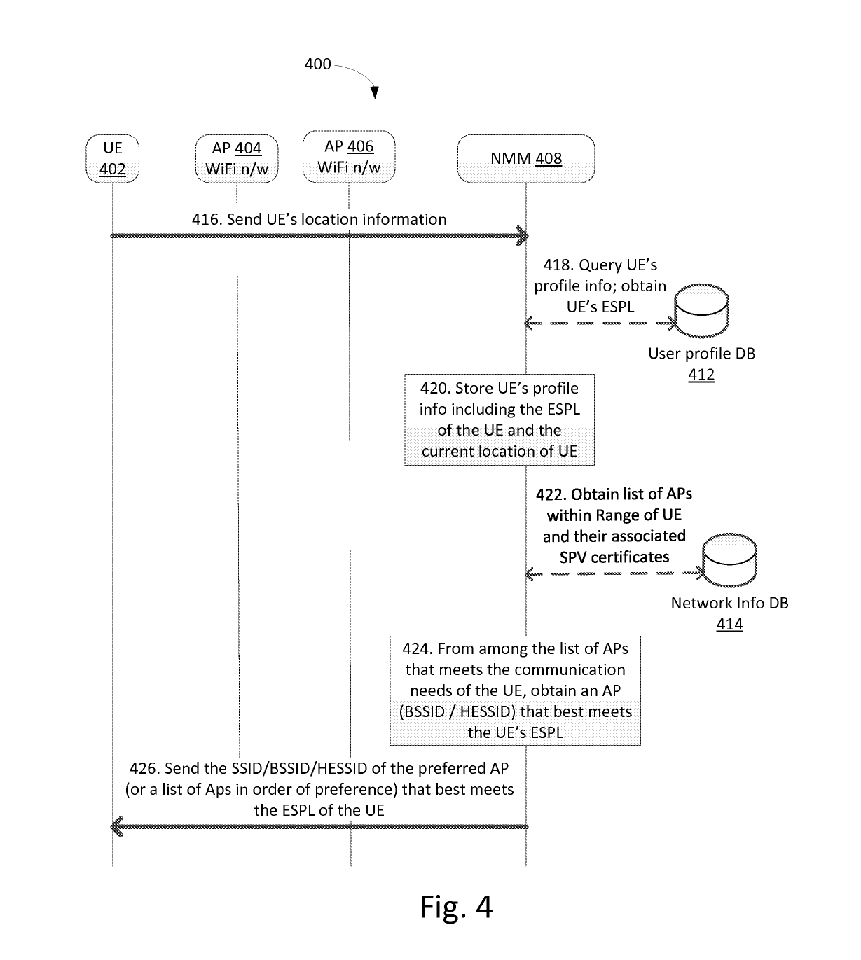

Referring now to FIG. 4, an example communication system 400 includes a UE 402, a first access point (AP) 404 to a WiFi network, a second access point 406 to a WiFi network, and a NMM 408, which communicate with each other. It will be appreciated that the example system 400 depicted in FIG. 4 and portions thereof are simplified to facilitate description of the disclosed subject matter and is not intended to limit the scope of this disclosure. Other devices, systems, and configurations may be used to implement the embodiments disclosed herein in addition to, or instead of, a system such as the system 400 depicted in FIG. 4, and all such embodiments are contemplated as within the scope of the present disclosure.

In accordance with the illustrated embodiment, the appropriate network that is selected is an 802.11 (WiFi) network. As shown, selection of hotspots for WiFi offloading may be performed by using the assistance of a MNO network, using protocols such as ANDSF, presented by way of example and without limitation. In accordance with the example, the UE 402 has a predefined expected security posture level (ESPL) associated with it that defines the minimum acceptable security of networks to which it will attach. The ESPL information is used in conjunction with security posture information of the Hotspot network obtained directly from the Hotspot or determined indirectly by the primary network in order to make network connectivity decisions.

Still referring to FIG. 4, in accordance with the illustrated example, at 416, the UE 402 may periodically provide its UE ID, its current location, and various context information (e.g., type of service or application being used, etc.) to the NMM 408. The information may be provided based on a pull/push mechanism initiated by a network function (e.g., NMM 408). Alternatively, the information associated with the UE 402 may be proactively sent by the UE 402 to the NMM 408. At 418, the NMM 408 may query, based on the identity (ID) of the UE 403 for example, a User Profile DB 412 to obtain profile information associated with the UE 402. The profile information may have been provided at 416. The NMM 408 may also obtain the ESPL of the UE 402 from the User Profile DB 412. At 420, in accordance with the illustrated example, the NMM 408 stores the UE's profile information with the ESPL of the UE 402. The NMM 408 may also store location information associated with the UE 402 that was retrieved from the database 412. At 422, the NMM function 408 may communicate with a Network Information database 414 and, using the location information of the UE 402, may obtain information from the database 414. Such information may include information about identities of access points (e.g., SSID, BSSID, HESSID) and the SPV of each access point that is geographically close to the vicinity of the UE 402. At 424, in accordance with the illustrated example, after retrieving the information about access points that are located in proximity to the UE 402, the NMM function 408 (PVB functionality may be incorporated with the NMM 408 or may exist separately), selects the AP whose SPV equals or exceeds the ESPL of the UE 402. Thus, the NMM 408 selects an AP that has an associated SPV that is adequate as compared to the ESPL of the UE 402. Alternatively, a list of access points may be compiled that each have SPVs that are adequate (e.g., exceeds or equals) as compared to the ESPL of the UE 402. In one example, the list is in order from best (e.g., highest SPV) access point to worst access points (e.g., least secure), although it will be understood that the list may be compiled in any order as desired. At 426, the NMM 408 sends the compiled list of access points in some preferred order (e.g., based on SPV, security capability, bandwidth, signal strength of the AP, cost to connect, etc.) to the UE 402. The UE 402 may then establish an association or a connection with an AP, for instance the first access point 404 or the second access point 406. If the UE 402 has multiple WiFi interfaces, it may connect with more than one AP that is in the list that was provided by the NMM 408.

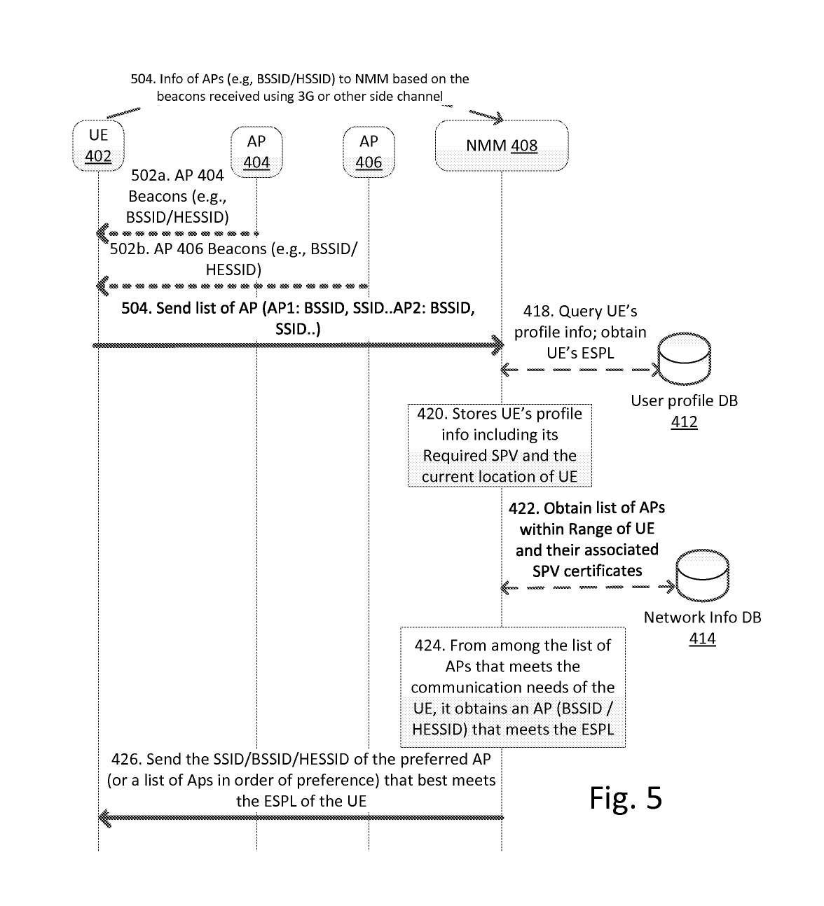

Referring now to FIG. 5, the example illustrated in FIG. 4 is altered. It will be understood that reference numbers may be repeated in different figures to indicate similar or the same features. At 502a, the UE 402 receives beacon signals from the first AP 404. The beacon signals include an identity (e.g., SSID, BSSID, or HESSID) associated with the AP 404. Similarly, at 502b, the UE 402 receives beacon signals from the second AP 406. The beacon signals include an identity (e.g., SSID, BSSID, or HESSID) associated with the AP 406. At 504, the UE 402 provides information to the NMM 408 about APs in vicinity of the UE 402 (e.g., AP 404 and AP 406) or WiFi networks to which the UE 402 would like to attach. The list of access points, for instance the first access point 404 and the second access point 406, whose beacons are received by the UE 404 (at 502a and 502b) are conveyed by the UE 402 to the NMM 408. The NMM 408, which may be co-located with a PVB, retrieves the SPV and other relevant information associated with the access points from the network information database 414 (at 422). At 426, as described above, the NMM 408 determines the appropriate AP for the UE 402 and conveys the identity of the AP that may be assigned as the preferred AP, based on the SPV of the AP and ESPL of the UE 402. In some cases, in addition to the list of access points that the UE 402 has conveyed to NMM 408, the NMM 408 may obtain information concerning additional APs that may not have been conveyed by the UE 402. Thus, a preferred AP that is selected may or may not have been included as part of the list of APs that the UE 402 had conveyed to the NMM 408 initially in step 504.

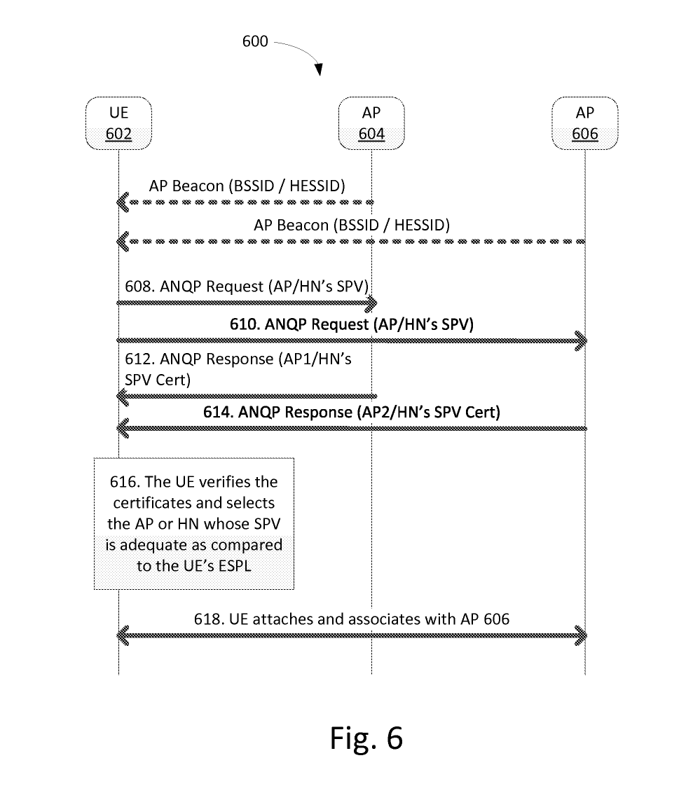

Referring now to FIG. 6, an example communication system 600 includes a UE 602, a first AP 604, and a second AP 606. It will be appreciated that the example system depicted 600 in FIG. 6 and portions thereof are simplified to facilitate description of the disclosed subject matter and is not intended to limit the scope of this disclosure. Other devices, systems, and configurations may be used to implement the embodiments disclosed herein in addition to, or instead of, a system such as the system 600 depicted in FIG. 6, and all such embodiments are contemplated as within the scope of the present disclosure.

As illustrated in FIG. 6, the UE 602 may select a hotspot without assistance from the network. In accordance with the illustrated example, the UE 602 obtains information about surrounding hotspots (e.g., AP 604 and AP 606) via the GAS interworking protocol that carries ANQP information. At 608, for example, the UE 602 sends the first AP 604 an ANQP request that requests an SPV associated with the AP 604 or the related hotspot network. Similarly, at 610, the UE 602 sends the first AP 604 an ANQP request that requests an SPV associated with the AP 606 or the related hotspot network. In accordance with the example embodiment, the hotspot networks can enhance the ANQP protocol to carry additional security posture (SPV) information associated with a given AP, for instance the first and second AP 604 and 606 (at 612 and 614). Thus, at 616, the UE 602 retrieves the SPV information of each hotspot network (e.g., AP 602 and AP 604) and compares it to its own ESPL, and determines whether each hotspot has adequate (suitable) security processes and protections in place. Alternatively, the AP or the Hotspot network may send a link (e.g., http link) or a certificate indicating the SPV of the AP or Hotspot network, which can then be retrieved and evaluated by the UE 402. Based on the SPV, the UE may connect to that hotspot network or to another network that meets its ESPL. In accordance with the illustrated example, the UE 602 determines that the second AP 606 best suits its needs, based on the SPV associated with the second AP 606, and the UE 602 establishes a connection with the AP 606, at 618.

It will be understood that the embodiments are not limited to selecting WiFi networks. Mechanisms that are similar or the same as the WiFi network selection described above may be used for network selection of UMTS/4G/5G systems, for example. In an example case of selecting other networks, such as a 4G LTE or 5G network for example, a trusted PVB may be used by an MNO to select appropriate trustworthy networks or eNBs operated by another operator or MNO. Such networks may be used to offload communications or provide a new attachment for the UE, and such networks may operate in different locations, for instance different countries, as compared to the primary network.

Turning now to selecting UEs based on SPVs, a network node may be able to obtain the SPV of a particular UE directly from the UE or indirectly by means of another network entity or third party trusted entity. A network may use this type of selection in order to ensure that only those UEs that meet its own ESPL are allowed to connect to its network. The SPV of the UE may contain various information elements, including information indicative of security applications on the device and their respective status (e.g., loaded or unloaded, active or inactive). For example, the UE may indicate various applications in security posture reporting such as anti-malware, anti-virus, intrusion detection, and OS versions, etc. Additionally, hardware specific information including trust module identification may also be present in the security posture reporting. Integrity validation results may also be provided as part of the security posture parameters.

Posture information may be obtained from another network, for example in a handover scenario. In this example case, additional posture information can include security credentials for authentication that may correspond to certificate information. In addition, the security algorithms supported by the UE, processes and policy evaluation, results of security vulnerability assessment of the UE that was conducted may be used to compute the SPV of the UE. The SPV may be represented in the form of the UE's SPV certificate or in the form the UE's SPV scorecards. As mentioned previously, a cumulative SPV may be created based on the various individual SPVs that were generated, which may be further based on the various types of evaluations (e.g., presence of malware protection software, presence of TPM, vulnerability assessment of OS etc.) performed on the entity (e.g. UE).

In an example use case scenario, the access network uses the SPV of a particular UE in order to make a policy based attachment decision. Networks may have a unique expected security posture level (ESPL) that defines the level of threat and associated risks and acceptable security practices. Networks may consider allowing or denying UE/user requests to access their networks based on the SPV of the UEs. During the network attach procedures, the SPV information may be provided by either the UE directly or indirectly by another network entity that has a trust or business relationship with the UE or a mutually trusted third party entity. The UE may provide its SPV, including various hardware and software security indications that may be assessed by the network, so that the network can determine if the UE may be a source of vulnerabilities that may be exploitable by an external entity or by the User/UE in order to impact the network (e.g., Denial-of-Service attacks) and/or the UE. Primary network assisted UE selection, which may closely align with Federated TNC, uses the UE's SP measurements that may be sent beforehand and evaluated apriori by the third party entity (e.g., MNO) and sent to the secondary network.

In another example embodiment, networks allow a UE to attach only based on information provided by the UE. For example, networks that have the ability to select a UE for attachment make the decision for allowing access to their networks based on information solely provided by the UE requesting attachment. The network may or may not have any prior knowledge of the UE based on previous attachments. The SPV may be used by the network in order to determine if the UE should be granted full or limited access, provided the SPV of the UE equals or exceeds the ESPL of the network. The security posture of a device can include parameters regarding the security applications on the device including their status (e.g., loaded or unloaded, active or inactive). Applications of note may include anti-malware, anti-virus, intrusion detection, presence of hardware-root-of-trust (TPM, UICC, TEE, etc.) and OS versions. Additionally, hardware specific information including trust module identification may also be present in the security posture reporting.

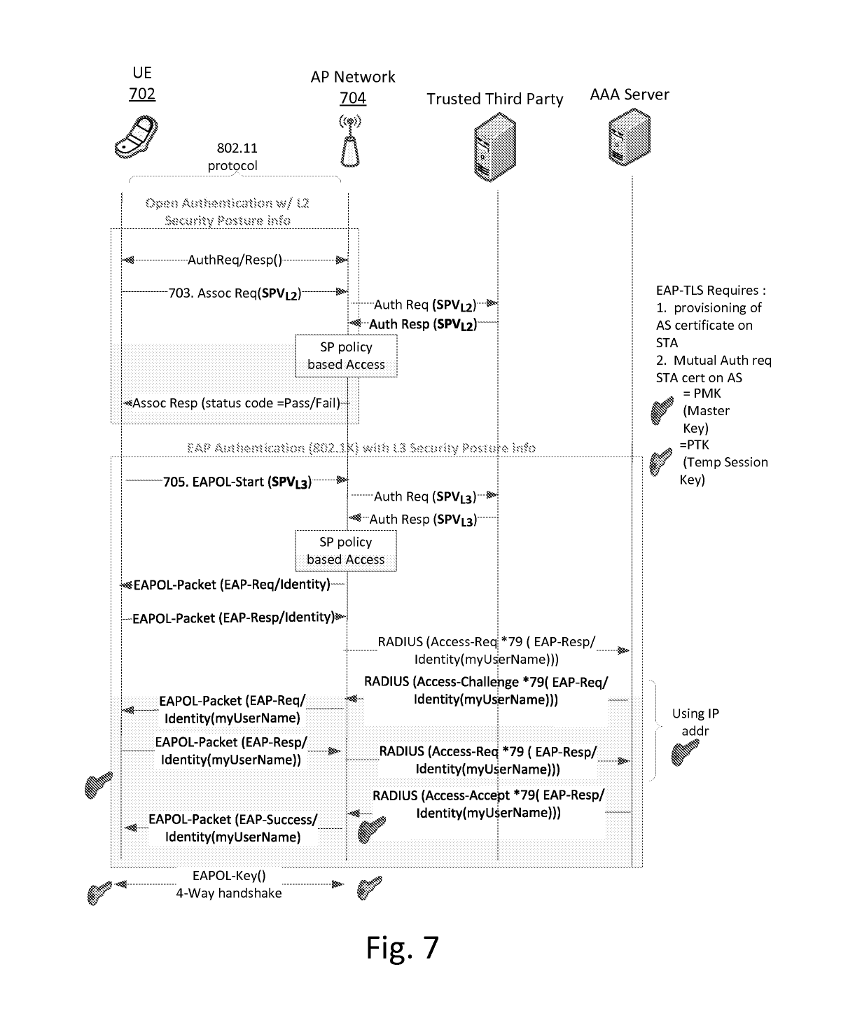

In some cases, referring to FIG. 7, a UE, for instance a UE 702, may provide its SPV to the network attachment process in a layered manner. For example, the UE 702 may provide initial security posture information that may be used during the association phase that would enable or prohibit further authentication based on the SPV information provided by the UE 702. If the initial association phase passes, the next phase (e.g., 802.1x authentication process) can proceed with additional security posture information. For example, at 703, the UE 702 may provide SPV_{L2}, which is the SPV relating to components associated with Layer 2 mechanisms (e.g., WiFi MAC/PHY device drivers, protocols, etc.) to an AP 704 using 802.11 messaging. At 705, the UE 702 may further provide SPV_{L3}, which is the SPV relating to components associated with Layer 3 mechanisms (e.g., IP Stack, firmware components, etc.), using EAP messages that provide the SPV relating to the security posture of the UE 702 that corresponds to higher layer protocols. The SPV_{L2} refers to the SPV associated with the firmware, software, and optionally the hardware associated with the Layer 2 authentication process. Similarly, the SPV_{L3} may be the SPV associated with another layer (e.g., IP layer, optionally MAC layer or any other relevant higher layer). This may be useful, for example, where the SPV of only certain components associated with the operation, service, or application may be applicable, and therefore the SPV of the entire platform might not be provided for certain security reasons (e.g., for privacy reasons).

Referring to FIG. 7, in accordance with the illustrated example, the layer 2 (L2) communicates the SPV analyzed during the “association” phase to determine if authentication should continue. If the L2 SPV is accepted by the AP 704, then the EAP authentication may carry additional layer 3 (L3) SPV information (e.g., certificate or scorecards) that can be used to make access control decisions. The UE 702 may also send certification information (e.g., level and Protection Profile information, FIPS certification information, etc.) as part of the SPV by means of various messaging protocol (e.g., EAP, HTTP, SCAP, etc.). Further, the UE 702 may send a security certificate (e.g., TEE ID or trust module certificate) in a vendor specific attribute using similar messaging as described above.

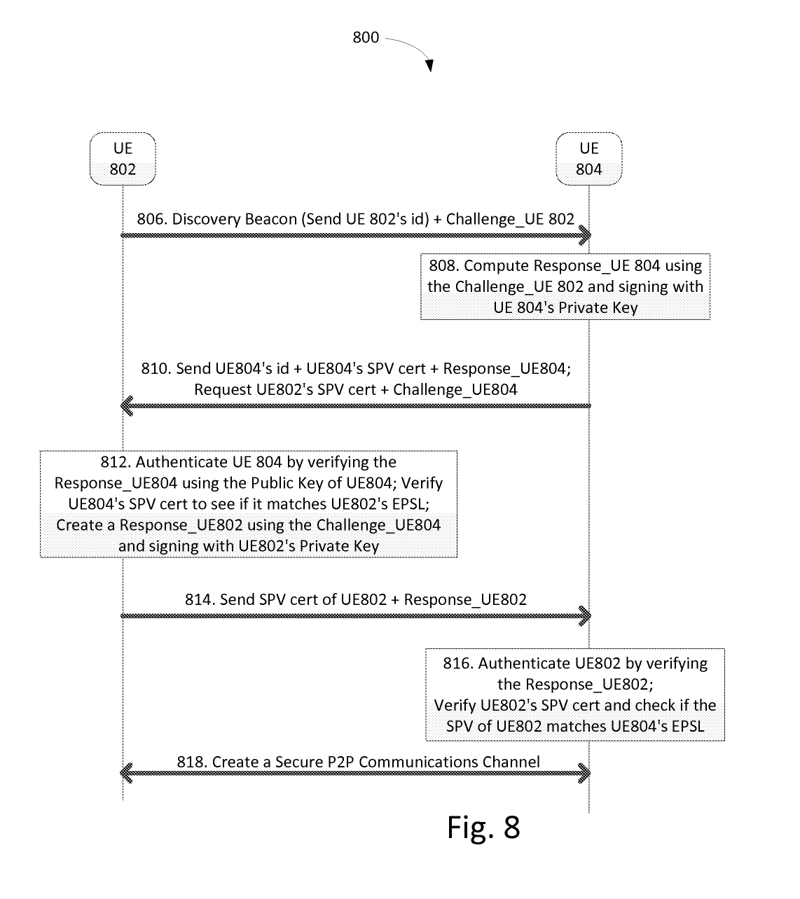

Referring now to FIG. 8, an example peer-to-peer (P2P) communication system 800 includes a first UE 802 and a second UE 804, which communicate with each other using P2P communications. It will be appreciated that the example system 800 depicted in FIG. 8 and portions thereof are simplified to facilitate description of the disclosed subject matter and is not intended to limit the scope of this disclosure. Other devices, systems, and configurations may be used to implement the embodiments disclosed herein in addition to, or instead of, a system such as the system 800 depicted in FIG. 8, and all such embodiments are contemplated as within the scope of the present disclosure.

By way of an example out-of-coverage scenario (without the assistance of a network provider), still referring to FIG. 8, a first user and a second user work with different fire departments in adjoining areas. Both users are participating in fighting a forest fire and would like to coordinate their activities with each other using Proximity Services (e.g., P2P or group communications). The first user would like to verify that the second UE 804 has an adequate Security Posture before communications start. Thus, at 806, the first UE 802 may request the Security Posture of the second UE 804. At 808, the second UE 804 may compute a response to request (challenge), and the UE 804 may sign the response using a private key of the UE 804. The UE 804 includes its SPV certificate as part of the signed message. In addition, the UE 804 may include a request to UE 802 for UE 802's SPV. At 810, the second UE 804 may send the response to the first UE 802 in a secure manner. At 812, the first UE 802 may verify the response using the pubic key of the second UE 804. The first UE 802 may determine whether the SPV of the second UE 804 is adequate as compared to the ESPL of the first UE 802. Furthermore, at 814, the first UE 802 may send the second UE 804 an SPV of the first UE 802. At 816, the second UE 804 may authenticate the first UE 802 by verifying the message received at 814. The second UE 804 may determine whether the SPV of the first UE 802 is adequate as compared to the ESPL of the second UE 804. If each SPV is adequate, the first UE 802 and the second UE 804 may establish a secure P2P communications channel between each other. Continuing with the example above, the SPV of both the first UE 802 and the second UE 804 may have to be greater than or greater or equal to a SPV approved by the fire departments.

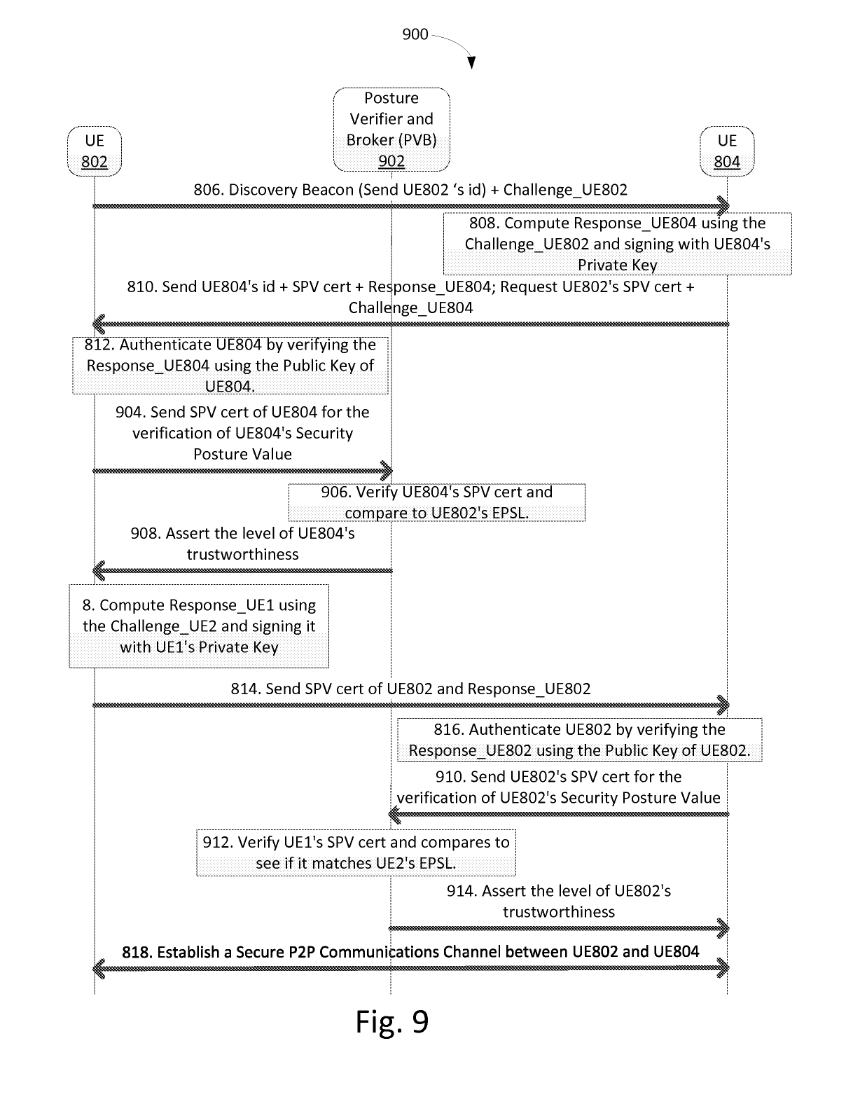

Referring now to FIG. 9, an example P2P communication system 900 includes a first UE 802, a PVB 902, and a second UE 804, which communicate with each other using P2P group communications. It will be appreciated that the example system 900 depicted in FIG. 9 and portions thereof are simplified to facilitate description of the disclosed subject matter and is not intended to limit the scope of this disclosure. Other devices, systems, and configurations may be used to implement the embodiments disclosed herein in addition to, or instead of, a system such as the system 900 depicted in FIG. 9, and all such embodiments are contemplated as within the scope of the present disclosure.

By way of an example of in-coverage scenario (with the assistance of network or service provider), still referring to FIG. 9, a first user (UE 802) wants to use P2P communications (e.g., game playing) and collaboration with a second user (UE 804), however, the first user is not sure if the second UE 804 is a source of malware, and therefore the first UE 802 desires to obtain some kind of assurance that the second UE 804 is malware-free (trustworthy). As shown, at 904, the first UE 802 may request that the network, in particular the PVB 902, vouches for the Security Posture (SPV) of the second UE 804. Similarly, at 910, the second UE 804 may request that the network, in particular the PVB 902, vouches for the Security Posture (SPV) of the first UE 802. At 906 and 912, the PVB 902 verifies the security posture values of the first and second UEs 802 and 804, respectively. Further, the SPVs of the first or second UE is compared to the ESPL of the other UE. At 908, the PVB 902 asserts a level of trustworthiness associated with the second UE 804 to the first UE 802. Similarly, at 914, the PVB 902 asserts a level of trustworthiness associated with the first UE 802 to the second UE 804. If both of the security posture values are adequate, in accordance with the illustrated example, a secure communications channel is established between the first and second UE (at 818). Thus, the PVB 902 may perform the security assessments on behalf of the UEs and provide the UEs with the results of the assessments as depicted in FIG. 9.

Turning now to connecting to trustworthy Service Providers (e.g., relying party (RP), Web portals, or Web applications), Service Providers may be able to vouch to potential customers/users about the trustworthiness of their web portals by advertising their security trustworthiness via means of an icon or symbol on the Service Provider's (SP/RP) website. As used herein, a service provider (SP) and a relying party (RP) are used interchangeable without limitation, unless otherwise specified. Currently, there might not be a way for an individual to infer the trustworthiness of a Webserver or Portal except based on hearsay and reputation. It is recognized herein that such indicators are subpar for determining the true trustworthiness of a website. In some cases, the only indication that a user might have from a Server/website/portal is that the server may use TLS (HTTPS), which is depicted by means of a “lock icon” on the web page, and which only indicates to the user that his/her traffic from the user's browser to the server is protected (confidentiality, integrity, and server authentication) during transit. Thus, in some cases, there is no indication about the operational security of the server or the infrastructure providing the services. No indication is available that indicates the security and controls such as, for example, application security controls, web-server security controls (such as protections against XSS attacks), OS security controls (such as Host-based intrusion prevention, malware protection: anti-virus/malware, etc.), database security and network security controls, etc. that the service provider has put in place in order to protect user information and data for security and privacy. So, the indication that a server runs HTTPS is only an indication of a security control for protection of data in transit, typically by way of a lock icon. In accordance with an example embodiment described herein, when a server and the systems behind the server, which enable the service, have been evaluated using a vulnerability assessment/penetration testing and is certified to have an SPV, then the Service Provider (SP/RP) may be able to display an indication of its security posture, so that users and applications may use the level of the SPV in order to make a determination for connecting with the Service Provider and obtaining services.

Security posture information may be embedded within a certificate. The certificate may be verified locally and signed by a third-party similar to an x.509 certificate. Security Posture information may be presented to users as an icon similar to the “Lock Icon” that is used to indicate the use of HTTPS (TLS). The icon may indicate the overall trust-worthiness of the Web-server and/or the trustworthiness of the entire or relevant components that form part of the Web-server network. The icon may present granular information in any appropriate manner as desired. For example, granular information may be presented in the form of colored icons (e.g., a red icon indicating a very low trust level, through a range of colors to a green color in order to indicate a very high-level of trust). Other means of indicating security levels may be employed. When a user sees the icon displayed on a portal, the user may be comforted in knowing that he/she is connecting to a trustworthy site. Applications may request the certificate from the webserver or non-web-service providers in order to make a decision on obtaining services from that Server based on the SPV of the Server and optionally the network behind the server (including supplementary servers, DBs, network etc.).

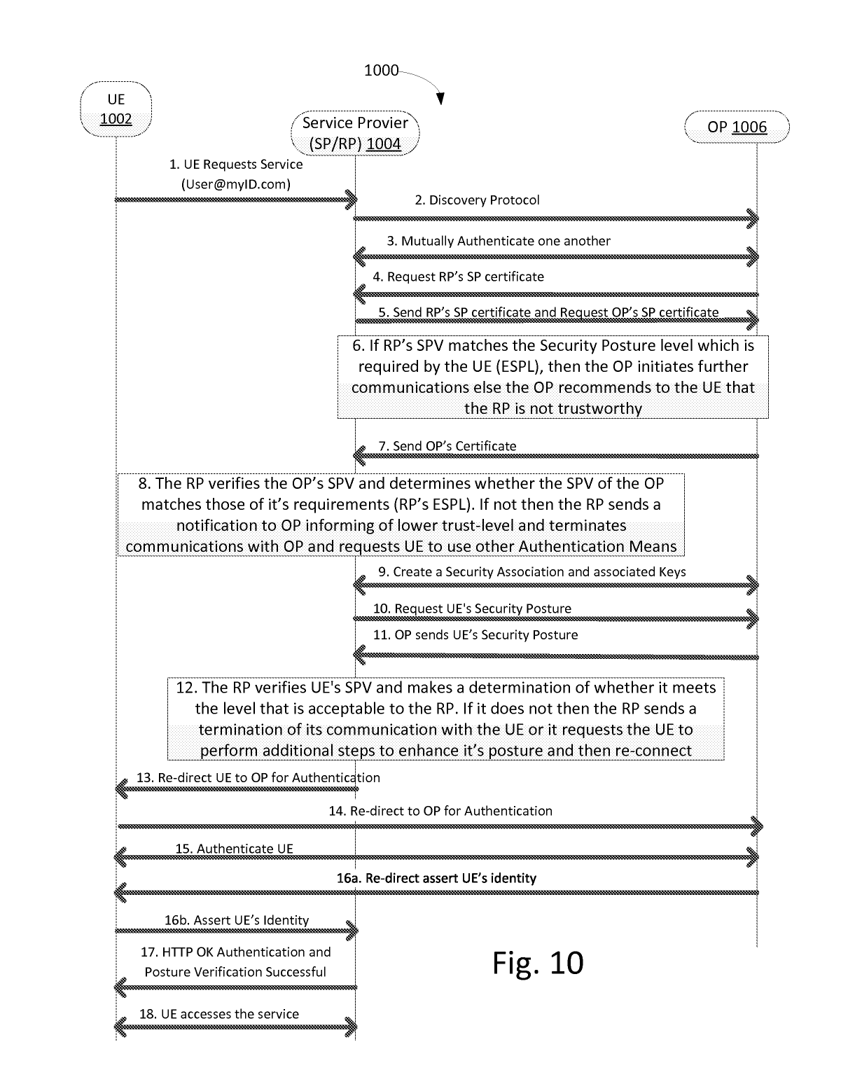

Referring now to FIG. 10, an example communication system 1000 includes a UE 1002, a service provider (SP) 1004 (e.g., a relying party (RP)), and an identity provider (e.g., an OpenID identity provider (OP)) 1006, which communicate with each other. The UE 1002 may also be referred to as a user or a UE/user, without limitation. The identity provider 1006 is also referred to herein as the OP 1006, but it will be understood that this reference is for purposes of example, and the identity provider 1006 is not limited to an OpenID identity provider. Similarly, the SP 1004 is also referred to herein as the RP 1004, but it will be understood that this reference is for purposes of example, and the SP 1004 is not limited to an OpenID relying party (RP). It will be appreciated that the example system 1000 depicted in FIG. 10 and portions thereof are simplified to facilitate description of the disclosed subject matter and is not intended to limit the scope of this disclosure. Other devices, systems, and configurations may be used to implement the embodiments disclosed herein in addition to, or instead of, a system such as the system 1000 depicted in FIG. 10, and all such embodiments are contemplated as within the scope of the present disclosure.

Referring to FIG. 10, in accordance with the illustrated embodiment, a service is provided to a user based on a determination that is made about the UE/User's SPV. In particular, a determination is made as to whether the SPV of the UE 1002 is adequate as compared to the ESPL of the SP 1004. At the same time, a determination is made by the UE 1002 (directly or indirectly, e.g., by a proxy serving on behalf of the UE 1002), that the SP's SPV is adequate as compared to the ESPL of the UE 1002. At 1, in accordance with the illustrated example, the UE 1002 requests service from the SP 1004, and uses an identity associated with a user of the UE (user@myID.com) or the UE 1002 to do so. The identity (ID) that is sent by the UE 1002 may be the user's subscriber ID or it may also be a device ID or subscription ID (e.g., IMSI). At 2, the SP 1004 may discover the identity provider 1006 of the UE/user by using procedures defined by standards (e.g., OpenID/OpenID Connect mechanisms, mechanisms from GBA specifications (TS 33.220)/OpenID—GBA specifications (TR 33.923), or the like). At 3, the RP 1004 and OP 1006 may optionally mutually authenticate one another.

Still referring to FIG. 10, in accordance with the illustrated example, at 4, the OP 1006 requests the RP's security posture certificate that contains the RP's SPV. At 5, the RP 1004 sends its SPV certificate or scorecard to the OP 1006, and requests the OP's security posture certificate. The RP 1004 may send only its own certificate or it may send a domain certificate that contains the SPV of the network/sub-network comprising the network components, databases, and other components that form the service domain to which the RP 1004 belongs. At 6, in accordance with the illustrated example, if the SPV of the RP 1004 (or the SPV of the domain to which the RP 1004 belongs) is adequate as compared to the ESPL of the UE 1002 and, in some cases, the ESPL of the OP 1006, then the OP 1006 processes the request from the RP 1004. If the SPV of the RP 1004 is not adequate as compared to, for instance less than, the ESPL of the UE 1002, then the OP 1006 may deny the request to process further. The OP 1006 may optionally indicate to the UE 1002 that the RP 1004 is not trustworthy. The OP 1006 may use an explicit signaling mechanism or may implicitly signal that the RP 1004 is not trustworthy by rejecting the OpenID authentication process. At 7, the OP 1006 sends its SPV certificate or SPV scorecard to the RP 1004. The exchanges of certificates (or scorecards) between the OP 1006 and the RP 1004 may be also be carried out during the message at 3 (as part of the Authentication phase, which may be optional). At 8, the RP 1004 verifies the OP's security posture certificate and determines if the SPV of the OP 1006 is adequate as compared to the RP's ESPL. If it is not adequate, then the RP 1004 determines that the OP 1006 is not trustworthy, and therefore may conclude that any assertions that might originate from the OP 1006 are not to be trusted. In some cases, the RP 1004 may provide curtailed services to the UE 1002, for example, if the SPV of the OP 1006 is less than (inadequate) as compared to the ESPL of the RP 1004. In some cases, the RP 1004 instructs the UE/user 1002 to use a different identity or a different identity provider (e.g., other subscription ID such as IMSI that is associated with an MNO, with whom the UE/User has a relationship and possibly an identity provider with higher trust-worthiness) with a higher trustworthiness in order to access the services offered by the RP 1004.

Still referring to FIG. 10, in accordance with the illustrated embodiment, at 9, when the SPV of the OP 1006 is adequate as compared to, for instance is at least equal to, the ESPL of the RP 1004, then the RP 1004 initiates a Secure Association with the OP 1006, and derives the appropriate keys to protect the communications between the RP 1004 and the OP 1006. Secure communication may be achieved using mechanisms at the IP layer, transport layer, or application layer (e.g., IPSec, TLS, etc.). At 10, the RP 1004 may request the UE's SPV certificate from the OP 1006. The OP 1006 may or may not have the UE's SPV. At 11, in some cases in which the OP 1006 has the UE's SPV certificate, the OP 1006 sends the certificate or scorecard to the RP 1004 on behalf of the UE 1002. This step may be deferred in cases where the OP 1006 does not have possession of the UE's SPV certificate. This step may also be omitted, for example in cases where the OP 1006 cannot access the UE's SPV certificate. At 12, in accordance with the illustrated example, if the RP 1004 is able to obtain the UE's SPV, then it verifies the UE's SPV certificate. If the SPV certificate is adequate as compared to the ESPL of the RP 1004, the OID authentication process continues. Conversely, if the SPV certificate is not adequate, then the RP 1004 may send a session termination request to the UE 1002. In some instances, the RP 1004 may continue with the authentication process even if the SPV of the UE 1002 was inadequate as compared to, for instance lower than, the RP's ESPL. For example, the UE 1002 may have authenticated with a higher-degree of assurance, such that the RP 1004 may provide the UE 1002 with a subset of services, for instance less than all the services, requested by the UE 1002. In some instances, the RP 1004 may request that the UE 1002 bolster its SPV and then reconnect to the RP 1004. This may be performed in a real-time manner or in non-real-time. In some cases, this step may be deferred, for example in cases in which the OP 1006 does not have possession of the UE's SPV certificate.

Still referring to the example illustrated in FIG. 10, at 13, the RP 1004 redirects the UE/user 1002 to the OP 1006 for authentication using mechanisms as specified by OpenID (OID), OID Connect, GBA, or the like. At 14, the UE 1002 is redirected to the OP 1006 for authentication. At 15, the OP 1006 may authenticate the UE/user 1002. In cases in which the OP 1006 did not have possession of the SPV certificate or scorecard of the UE 1002, the OP 1006 may request that the UE 1002 supply the SPV certificate to the OP 1006. In certain scenarios, the UE 1002 may decline the request from the OP 1006 for its SPV certificate, for example by citing privacy and security reasons. This may be particularly true if the SPV certificate has been issued by entities that belong to certain high-security agencies, and if the SPV is required for providing services to UEs from certain “high-security” RPs. The UE 1002 may choose to share the certificates directly with the RP of interest and may be secured within a secure element within the UE 1002. In some cases, a UE may have more than one SPV certificate issued by multiple entities (e.g., certificate from an identity provider, another from .gov agencies, etc.). The SPV certificate may be chosen based on the identity that the UE/user uses for accessing a particular service. Certain services may be requested based on certain identities and an associated SPV certificate, while other services may be requested based on another identity and a different associated SPV certificate. At 16a and 16b, the OP 1006 asserts the UE's identity and optionally the trustworthiness of the UE 1002 to the RP 1004, which includes sending a redirect message to the UE 1002 (at 16a). At 17, the RP 1004 verifies the assertion and sends an HTTP OK message to the UE 1002. At 18, the UE/user 1002 is provided with access to services offered by the RP 1004. The services offered by the RP 1004 may be based on the SPV evaluation process that was carried out by the RP 1004 during earlier steps described above. In certain cases, the RP 1004 is provided with an access token (e.g., OpenID Connect: JWT token), which is then used by the RP 1004 to access the UE 1002's SPV certificate from a token endpoint (e.g., an SPV repository) or presented to the smart card on the UE 1002 so that the smart card releases the SPV of the UE 1002.

Thus, to summarize, as described above, various embodiments include the following features, presented by way of example and without limitation:
Determination of Security Posture Values that may be based on a combination of security evaluations assessments (e.g., vulnerability assessment, pen-testing, threat-risk-assessment, compliance to risk assessment standards, implementation of best practices, deployment of security controls: malware protection mechanisms, security policies, etc.)
Network discovery and attachment of a UE based on a priori knowledge about the Security Posture Value (SPV) of a network (e.g., WiFi Access Point or Network Server)
Network discovery and attachment based on a priori knowledge about the Security Posture of the Cellular Network and or Base Station (eNB), NodeB
A priori-knowledge of Security Posture of the UE prior to Network attach procedures.
Layered Policy Enforcement using Security Posture information for network attach procedures
Determination of Trust-worthy Service Providers or Relying Parties using the SPV of the RP/SP so that a User/UE can connect to an SP in order to obtain access to a service or applications.
Using Security Posture Values in determining trust-worthiness of an OP or Authentication Services provided by Over-The-Top service providers (OTT)- or Network Application Function (NAF) or Bootstrapping Function within MNO network.
Use of Federated Identity systems for retrieval of security posture information.
Representation of Security Posture in the form of a Certificate of Security Posture
Usage of Security Posture in order to establish peer-to-peer connection between two UEs.
Usage of Security Posture in order to establish connections between sensor nodes and gateways or other entities involved in Machine-to-Machine (M2M) or Internet-of-Things (IoT) setup
Usage of Security Posture values of UEs in determining allowance to a multicast group and establishing group communications.
Fitness level of devices including SPV for accessing certain services that may be enforced by an app or service provider based on an Expected Security Posture Level (ESPL) associated with the app or service.

Further, as described above, network attachment decisions may be based on a combination of a Security Posture Value (SPV) of an End User Device, a Security Posture (SPV) of the target Network or Service Provider or a third-party service provider, a Security Posture Value of service enabling entities such as Authentication Servers, Identity Providers (OP), Bootstrapping functions (e.g., NAF, BSF), or the like.

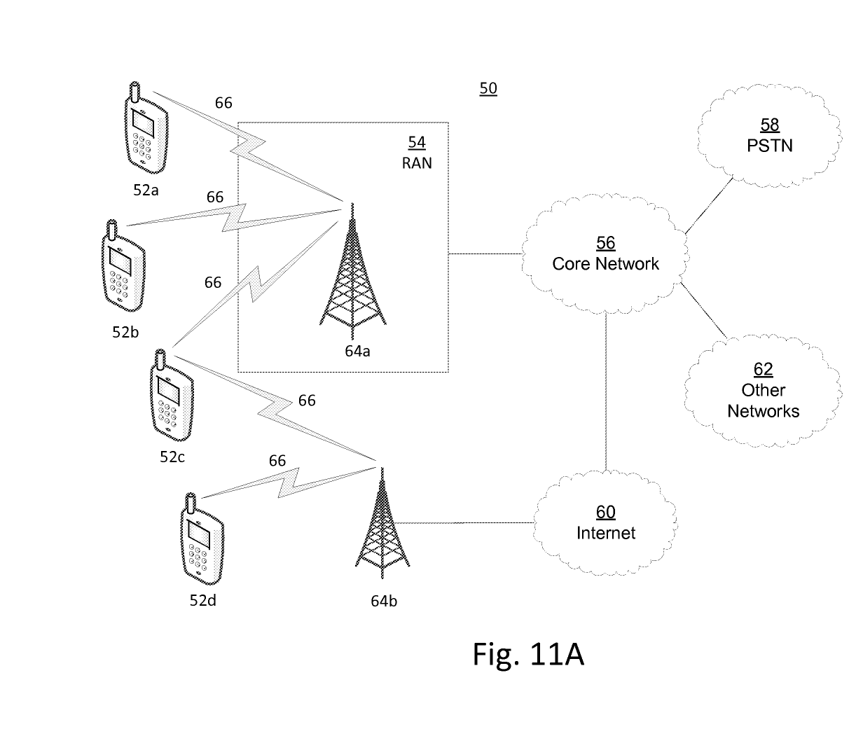

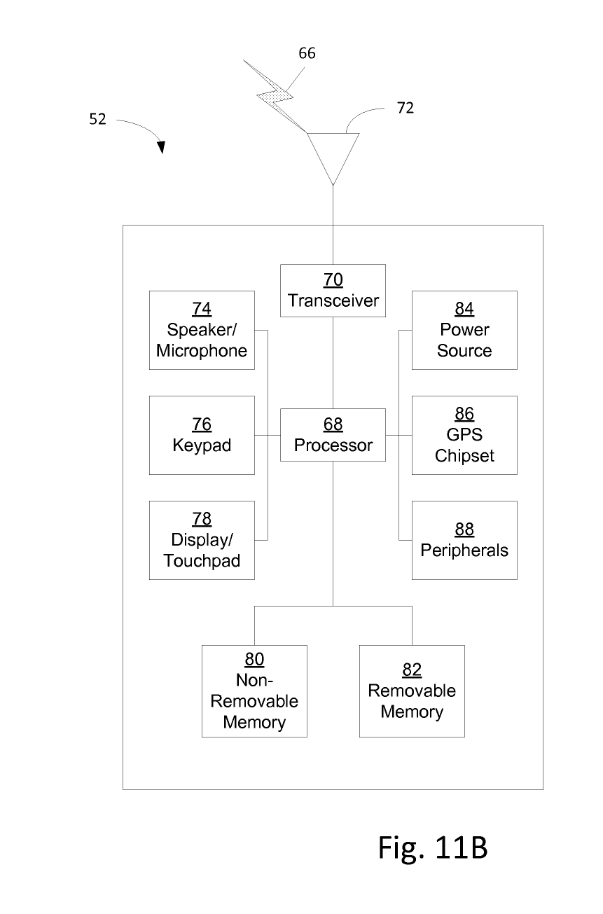

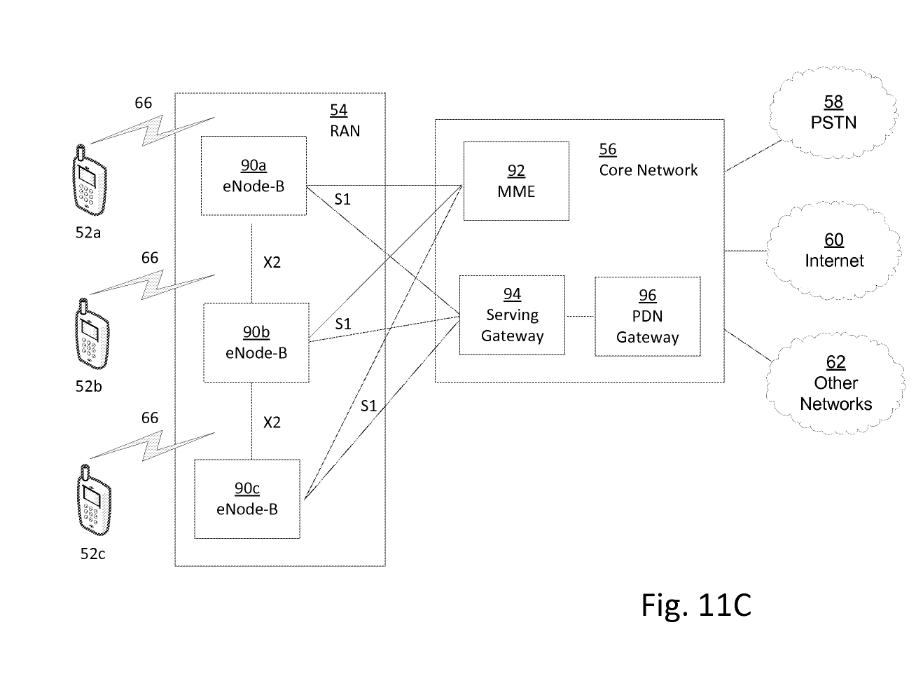

FIG. 11A is a diagram of an example communications system 50 in which one or more disclosed embodiments may be implemented. The communications system 50 may be a multiple access system that provides content, such as voice, data, video, messaging, broadcast, etc., to multiple wireless users. The communications system 50 may enable multiple wireless users to access such content through the sharing of system resources, including wireless bandwidth. For example, the communications systems 50 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 11A, the communications system 50 may include wireless transmit/receive units (WTRUs) 52a, 52b, 52c, 52d, a radio access network (RAN) 54, a core network 56, a public switched telephone network (PSTN) 58, the Internet 60, and other networks 62, though it will be appreciated that the disclosed embodiments contemplate any number of WTRUs, base stations, networks, and/or network elements. Each of the WTRUs 52a, 52b, 52c, 52d may be any type of device configured to operate and/or communicate in a wireless environment. By way of example, the WTRUs 52a, 52b, 52c, 52d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 50 may also include a base station 64a and a base station 64b. Each of the base stations 64a, 64b may be any type of device configured to wirelessly interface with at least one of the WTRUs 52a, 52b, 52c, 52d to facilitate access to one or more communication networks, such as the core network 56, the Internet 60, and/or the networks 62. By way of example, the base stations 64a, 64b may be a base transceiver station (BTS), a Node-B, an eNode B, a Home Node B, a Home eNode B, a site controller, an access point (AP), a wireless router, and the like. While the base stations 64a, 64b are each depicted as a single element, it will be appreciated that the base stations 64a, 64b may include any number of interconnected base stations and/or network elements.

The base station 64a may be part of the RAN 54, which may also include other base stations and/or network elements (not shown), such as a base station controller (BSC), a radio network controller (RNC), relay nodes, etc. The base station 64a and/or the base station 64b may be configured to transmit and/or receive wireless signals within a particular geographic region, which may be referred to as a cell (not shown). The cell may further be divided into cell sectors. For example, the cell associated with the base station 64a may be divided into three sectors. Thus, in an embodiment, the base station 64a may include three transceivers, i.e., one for each sector of the cell. In an embodiment, the base station 64a may employ multiple-input multiple output (MIMO) technology and, therefore, may utilize multiple transceivers for each sector of the cell.

The base stations 64a, 64b may communicate with one or more of the WTRUs 52a, 52b, 52c, 52d over an air interface 66, which may be any suitable wireless communication link (e.g., radio frequency (RF), microwave, infrared (IR), ultraviolet (UV), visible light, etc.). The air interface 66 may be established using any suitable radio access technology (RAT).

More specifically, as noted above, the communications system 50 may be a multiple access system and may employ one or more channel access schemes, such as CDMA, TDMA, FDMA, OFDMA, SC-FDMA, and the like. For example, the base station 64a in the RAN 54 and the WTRUs 52a, 52b, 52c may implement a radio technology such as Universal Mobile Telecommunications System (UMTS) Terrestrial Radio Access (UTRA), which may establish the air interface 66 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 64a and the WTRUs 52a, 52b, 52c may implement a radio technology such as Evolved UMTS Terrestrial Radio Access (E-UTRA), which may establish the air interface 66 using Long Term Evolution (LTE) and/or LTE-Advanced (LTE-A).

In other embodiments, the base station 64a and the WTRUs 52a, 52b, 52c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 64b in FIG. 11A may be a wireless router, Home Node B, Home eNode B, femto cell base station, or access point, for example, and may utilize any suitable RAT for facilitating wireless connectivity in a localized area, such as a place of business, a home, a vehicle, a campus, and the like. In an embodiment, the base station 64b and the WTRUs 52c, 52d may implement a radio technology such as IEEE 802.11 to establish a wireless local area network (WLAN). In an embodiment, the base station 64b and the WTRUs 52c, 52d may implement a radio technology such as IEEE 802.15 to establish a wireless personal area network (WPAN). In yet an embodiment, the base station 64b and the WTRUs 52c, 52d may utilize a cellular-based RAT (e.g., WCDMA, CDMA2000, GSM, LTE, LTE-A, etc.) to establish a picocell or femtocell. As shown in FIG. 11A, the base station 64b may have a direct connection to the Internet 60. Thus, the base station 64b may not be required to access the Internet 60 via the core network 56.

The RAN 54 may be in communication with the core network 56, which may be any type of network configured to provide voice, data, applications, and/or voice over internet protocol (VoIP) services to one or more of the WTRUs 52a, 52b, 52c, 52d. For example, the core network 56 may provide call control, billing services, mobile location-based services, pre-paid calling, Internet connectivity, video distribution, etc., and/or perform high-level security functions, such as user authentication. Although not shown in FIG. 11A, it will be appreciated that the RAN 54 and/or the core network 56 may be in direct or indirect communication with other RANs that employ the same RAT as the RAN 54 or a different RAT. For example, in addition to being connected to the RAN 54, which may be utilizing an E-UTRA radio technology, the core network 56 may also be in communication with another RAN (not shown) employing a GSM radio technology.

The core network 56 may also serve as a gateway for the WTRUs 52a, 52b, 52c, 52d to access the PSTN 58, the Internet 60, and/or other networks 62. The PSTN 58 may include circuit-switched telephone networks that provide plain old telephone service (POTS). The Internet 60 may include a global system of interconnected computer networks and devices that use common communication protocols, such as the transmission control protocol (TCP), user datagram protocol (UDP) and the internet protocol (IP) in the TCP/IP internet protocol suite. The networks 62 may include wired or wireless communications networks owned and/or operated by other service providers. For example, the networks 62 may include another core network connected to one or more RANs, which may employ the same RAT as the RAN 54 or a different RAT.

Some or all of the WTRUs 52a, 52b, 52c, 52d in the communications system 800 may include multi-mode capabilities, i.e., the WTRUs 52a, 52b, 52c, 52d may include multiple transceivers for communicating with different wireless networks over different wireless links. For example, the WTRU 52c shown in FIG. 11A may be configured to communicate with the base station 64a, which may employ a cellular-based radio technology, and with the base station 64b, which may employ an IEEE 802 radio technology.

FIG. 11B is a system diagram of a node, such as a node that is implemented in FIGS. 1 and 3-10, for instance a UE, AP, or WTRU 52. As shown in FIG. 11B, the WTRU 52 may include a processor 68, a transceiver 70, a transmit/receive element 72, a speaker/microphone 74, a keypad 76, a display/touchpad 78, non-removable memory 80, removable memory 82, a power source 84, a global positioning system (GPS) chipset 86, and other peripherals 88. It will be appreciated that the WTRU 52 may include any sub-combination of the foregoing elements while remaining consistent with an embodiment.

The processor 68 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 68 may perform signal coding, data processing, power control, input/output processing, and/or any other functionality that enables the WTRU 52 to operate in a wireless environment. The processor 68 may be coupled to the transceiver 70, which may be coupled to the transmit/receive element 72. While FIG. 11B depicts the processor 68 and the transceiver 70 as separate components, it will be appreciated that the processor 68 and the transceiver 70 may be integrated together in an electronic package or chip. The processor 68 may perform application-layer programs (e.g., browsers) and/or radio access-layer (RAN) programs and/or communications. The processor 68 may perform security operations such as authentication, security key agreement, and/or cryptographic operations, such as at the access-layer and/or application layer for example.

The transmit/receive element 72 may be configured to transmit signals to, or receive signals from, a base station (e.g., the base station 64a) over the air interface 66. For example, in an embodiment, the transmit/receive element 72 may be an antenna configured to transmit and/or receive RF signals. In an embodiment, the transmit/receive element 72 may be an emitter/detector configured to transmit and/or receive IR, UV, or visible light signals, for example. In yet an embodiment, the transmit/receive element 72 may be configured to transmit and receive both RF and light signals. It will be appreciated that the transmit/receive element 72 may be configured to transmit and/or receive any combination of wireless signals.

In addition, although the transmit/receive element 72 is depicted in FIG. 11B as a single element, the WTRU 52 may include any number of transmit/receive elements 72. More specifically, the WTRU 52 may employ MIMO technology. Thus, in an embodiment, the WTRU 52 may include two or more transmit/receive elements 72 (e.g., multiple antennas) for transmitting and receiving wireless signals over the air interface 66.

The transceiver 70 may be configured to modulate the signals that are to be transmitted by the transmit/receive element 72 and to demodulate the signals that are received by the transmit/receive element 72. As noted above, the WTRU 52 may have multi-mode capabilities. Thus, the transceiver 70 may include multiple transceivers for enabling the WTRU 52 to communicate via multiple RATs, such as UTRA and IEEE 802.11, for example.

The processor 68 of the WTRU 52 may be coupled to, and may receive user input data from, the speaker/microphone 74, the keypad 76, and/or the display/touchpad 78 (e.g., a liquid crystal display (LCD) display unit or organic light-emitting diode (OLED) display unit). The processor 68 may also output user data to the speaker/microphone 74, the keypad 76, and/or the display/touchpad 78. In addition, the processor 68 may access information from, and store data in, any type of suitable memory, such as the non-removable memory 80 and/or the removable memory 82. The non-removable memory 80 may include random-access memory (RAM), read-only memory (ROM), a hard disk, or any other type of memory storage device. The removable memory 82 may include a subscriber identity module (SIM) card, a memory stick, a secure digital (SD) memory card, and the like. In other embodiments, the processor 68 may access information from, and store data in, memory that is not physically located on the WTRU 52, such as on a server or a home computer (not shown).

The processor 68 may receive power from the power source 84, and may be configured to distribute and/or control the power to the other components in the WTRU 52. The power source 84 may be any suitable device for powering the WTRU 52. For example, the power source 84 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 68 may also be coupled to the GPS chipset 86, which may be configured to provide location information (e.g., longitude and latitude) regarding the current location of the WTRU 52. In addition to, or in lieu of, the information from the GPS chipset 86, the WTRU 52 may receive location information over the air interface 816 from a base station (e.g., base stations 64a, 64b) and/or determine its location based on the timing of the signals being received from two or more nearby base stations. It will be appreciated that the WTRU 52 may acquire location information by way of any suitable location-determination method while remaining consistent with an embodiment.

The processor 68 may further be coupled to other peripherals 88, which may include one or more software and/or hardware modules that provide additional features, functionality and/or wired or wireless connectivity. For example, the peripherals 88 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 11C is a system diagram of the RAN 54 and the core network 806 according to an embodiment. As noted above, the RAN 54 may employ a UTRA radio technology to communicate with the WTRUs 52a, 52b, 52c over the air interface 66. The RAN 54 may also be in communication with the core network 806. As shown in FIG. 11C, the RAN 54 may include Node-Bs 90a, 90b, 90c, which may each include one or more transceivers for communicating with the WTRUs 52a, 52b, 52c over the air interface 66. The Node-Bs 90a, 90b, 90c may each be associated with a particular cell (not shown) within the RAN 54. The RAN 54 may also include RNCs 92a, 92b. It will be appreciated that the RAN 54 may include any number of Node-Bs and RNCs while remaining consistent with an embodiment.

As shown in FIG. 11C, the Node-Bs 90a, 90b may be in communication with the RNC 92a. Additionally, the Node-B 90c may be in communication with the RNC 92b. The Node-Bs 90a, 90b, 90c may communicate with the respective RNCs 92a, 92b via an Iub interface. The RNCs 92a, 92b may be in communication with one another via an Iur interface. Each of the RNCs 92a, 92b may be configured to control the respective Node-Bs 90a, 90b, 90c to which it is connected. In addition, each of the RNCs 92a, 92b may be configured to carry out and/or support other functionality, such as outer loop power control, load control, admission control, packet scheduling, handover control, macrodiversity, security functions, data encryption, and the like.

The core network 56 shown in FIG. 11C may include a media gateway (MGW) 844, a mobile switching center (MSC) 96, a serving GPRS support node (SGSN) 98, and/or a gateway GPRS support node (GGSN) 99. While each of the foregoing elements are depicted as part of the core network 56, it will be appreciated that any one of these elements may be owned and/or operated by an entity other than the core network operator.

The RNC 92a in the RAN 54 may be connected to the MSC 96 in the core network 56 via an IuCS interface. The MSC 96 may be connected to the MGW 94. The MSC 96 and the MGW 94 may provide the WTRUs 52a, 52b, 52c with access to circuit-switched networks, such as the PSTN 58, to facilitate communications between the WTRUs 52a, 52b, 52c and traditional land-line communications devices.

The RNC 92a in the RAN 54 may also be connected to the SGSN 98 in the core network 806 via an IuPS interface. The SGSN 98 may be connected to the GGSN 99. The SGSN 98 and the GGSN 99 may provide the WTRUs 52a, 52b, 52c with access to packet-switched networks, such as the Internet 60, to facilitate communications between and the WTRUs 52a, 52b, 52c and IP-enabled devices.

As noted above, the core network 56 may also be connected to the networks 62, which may include other wired or wireless networks that are owned and/or operated by other service providers.

Although features and elements are described above in particular combinations, each feature or element can be used alone or in any combination with the other features and elements. Additionally, the embodiments described herein are provided for exemplary purposes only. Furthermore, the embodiments described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. In a system comprising a first node and a second node, a method performed at the first node, the method comprising:
receiving a security posture associated with the second node, wherein the security posture provides a verifiable point-in-time trust metric on an overall level of trust in the second node;
comparing the security posture associated with the second node to an expected security posture level associated with the first node, wherein the security posture associated with the second node and the expected security posture level associated with the first node are represented as respective numerical or qualitative values; and
if the security posture associated with the second node is adequate as compared to the expected security posture level, establishing a connection between the first node and the second node.

2. The method as recited in claim 1, wherein the first node is a user equipment, the second node is a network access point, and the established connection includes a network access for the user equipment.

3. The method as recited in claim 1, wherein the first node is a network access point, the second node is a user equipment, and the established connection includes a network access for the user equipment.

4. The method as recited in claim 1, wherein the first node is a first user equipment, and the second node is a second user equipment, and the established connection is a peer-to-peer communication session.

5. The method as recited in claim 1, wherein the first node is a user equipment, the second node is a service provider, and the established connection includes access to a service provided by the service provider.

6. The method as recited in claim 5, wherein a granular indication represents the security posture of the service, and the granular indication is displayed to a user of the user equipment.

7. A first node comprising, a processor, a memory, and communication circuitry, the first node configured to connect to a communications network via the communication circuitry, the first node comprising computer-executable instructions stored in the memory of the first node which, when executed by the processor of the first node, perform operations comprising:
receiving a security posture associated with the second node, wherein the security posture provides a verifiable point-in-time trust metric on an overall level of trust in the second node;
comparing the security posture associated with the second node to an expected security posture level associated with the first node, wherein the security posture associated with the second node and the expected security posture level associated with the first node are represented as respective numerical or qualitative values; and
if the security posture associated with the second node is adequate as compared to the expected security posture level, establishing a connection between the first node and the second node.

8. The first node as recited in claim 7, wherein the first node is a user equipment, the second node is a network access point, and the established connection includes a network access for the user equipment.

9. The first node as recited in claim 7, wherein the first node is a network access point, the second node is a user equipment, and the established connection includes a network access for the user equipment.

10. The first node as recited in claim 7, wherein the first node is a first user equipment, and the second node is a second user equipment, and the established connection is a peer-to-peer communication session.

11. The first node as recited in claim 7, wherein the first node is a user equipment, the second node is a service provider, and the established connection includes access to a service provided by the service provider.

12. The first node as recited in claim 7, wherein a granular indication represents the security posture of the service, and the granular indication is displayed to a user of the user equipment.

13. The first node as recited in claim 7, wherein the security posture is contained within a certificate or scorecard.
